(19) United States
(12) Patent Application Publication
(10) Pub. No.: US 2008/0091974 A1
(43) Pub. Date: Apr. 17, 2008

(54) Device for controlling a multi-core CPU for mobile body, and operating system for the same

(75) Inventor: Yasuo Nakashima, Tokyo (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/907,107

(22) Filed: Oct. 9, 2007

(30) Foreign Application Priority Data
Oct. 11, 2006 (JP) 2006-277790
Nov. 15, 2006 (JP) 2006-309352

(51) Int. Cl. G06F 11/07

(52) U.S. Cl. 714/10; 714/E11.021

(57) ABSTRACT

Temperatures of four CPU cores of a multi-core CPU of a mobile body are detected. If the detected temperatures of the CPU cores become high, a clock setting register in a CPU clock-forming unit is set to the highest multiplying factor, and the CPU clock multiplying factors of the other clock setting registers are lowered. The clock frequencies of the CPU cores are lowered except a specified CPU core of a highest priority while maintaining the highest operation clock frequency for the specified CPU core, to thereby lower the temperature of the multi-core CPU. Alternatively, when the specified CPU core becomes abnormal, the processing assigned to it is reassigned to another CPU core of the plurality of CPU cores.

### CROSS REFERENCE TO RELATED APPLICATION

This application relates to and incorporates herein by reference Japanese Patent Applications No. 2006-277790 filed on Oct. 11, 2006 and No. 2006-309352 filed on Nov. 15, 2006.

### FIELD OF THE INVENTION

The present invention relates to a technology for controlling a multi-core CPU for a mobile body including a plurality of CPU cores.

### BACKGROUND OF THE INVENTION

It is known by JP 2001-67149A to monitor a chip temperature by a CPU and lower an operation clock frequency of the CPU when the chip temperature exceeds a threshold value. Thus, the heat generation amount of the chip is decreased and the chip temperature is lowered in order to continue a normal operation of the CPU

However, a decrease in the operation clock frequency for lowering the heat generation amount of the chip results in a decrease in the processing capability of the CPU. If the above technology is applied to, for example, a vehicle controller incorporating the CPU, performance of the CPU drops. As a result, it may become difficult to normally execute the control related to the safety of the vehicle among the vehicle control operations.

It is also known by US 2005/0102565A1 that an object type multi-processing operating system is, in many cases, applied by handling a plurality of CPU cores as a single CPU. This operating system (OS) is a symmetric multi-processing (SMP) type.

In a system in which the above SMP type OS is applied to the multi-core CPU, a cycle is provided for executing a software for troubleshooting the CPU cores among the execution of software for realizing the system functions, and software for realizing the system function and the software for troubleshooting the CPU cores are executed in parallel.

In case it is so diagnosed that a particular CPU core is defective, the defective CPU core is purged, and the system operation is continued by constructing the SMP type OS using the remaining CPU cores only.

However, the above SMP type OS are not designed to distribute the CPU resources depending upon the importance of the software. In case the CPU core becomes defective, therefore, the number of the CPU cores assigned to the SMP type OS decreases causing a problem of a decrease in the software processing capability of the multi-core CPU as a whole.

In applying the above SMP type OS to, for example, a drive assist device for assisting the driving of a vehicle, if one CPU core becomes defective, the processing in advance of the trouble is executed by the remaining CPU cores.

Therefore, a CPU resource is occupied by image-decoding processing of dynamic data having a large processing load, and the software processing of an important function directly related to the safety such as assisting the driving is not executed in time, or the communication processing which operates being linked to an engine ECU is not finished within a predetermined period of time and the drive assist function is not performed.

### SUMMARY OF THE INVENTION

It is therefore an object of this invention to provide a technology for controlling a multi-core CPU for a mobile body, which can maintain execution of high priority processing even when a certain CPU core fails to operate normally.

According to a first aspect, a multi-core CPU for a mobile body includes a plurality of CPU cores to which different processing are assigned, respectively. An abnormal condition that lowers processing capability of the multi-core CPU is detected. Priority degrees of the respective processing assigned to the plurality of CPU cores are stored. The processing capabilities of the plurality of CPU cores are adjustable. When the abnormal condition is detected the processing capabilities of the CPU cores are lowered depending upon the priority degrees except that of a specified CPU core among the plurality of CPU cores. The specified CPU core is assigned a highest degree of priority.

According to a second aspect, a multi-core CPU for a mobile body includes a plurality of CPU cores to which different processing are assigned, respectively. An abnormal condition that indicates incapability of assigned processing in any one of the plurality of CPU cores is detected. When the abnormal condition is detected, the processing that has been assigned to an abnormal one of the plurality of CPU cores is reassigned to a normal one of the plurality of CPU cores other than the abnormal one depending upon a predetermined order of priorities.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic view of a car navigation device according to a first embodiment of the present invention;

FIG. 2 is a block diagram schematically illustrating a system construction of the first embodiment;

FIG. 3 is a flowchart illustrating supervisory processing executed by a control unit in the first embodiment;

FIGS. 4A and 4B are relations of a CPU clock frequency ratio relative to a CPU core temperature in the first embodiment; and

FIG. 5 is a flowchart of control processing in an application software in the first embodiment;

FIG. 6 is a block diagram schematically illustrating a system construction of a car navigation device according to a second embodiment of the present invention;

FIG. 7 is a flowchart illustrating main processing executed by a control unit in the second embodiment;

FIG. 8 is a flowchart illustrating abnormal condition detection processing executed in the second embodiment;

FIG. 9 is a flowchart illustrating reassigning processing executed in the second embodiment;

FIG. 10 is a flowchart illustrating SMP side CPU core reassigning processing executed in the second embodiment;

FIG. 11 is a flowchart illustrating AMP side CPU core reassigning processing executed in the second embodiment;

FIG. 12 is a block diagram schematically illustrating a software construction in a microcomputer of when an abnormal condition has occurred in a first CPU core;

FIG. 13 is a diagram illustrating a relationship of transition in a state where the operating system and the application software are assigned in case abnormal conditions have occurred in the CPU cores in a state where the multi-core CPU is normally operating; and

FIG. 14 is a flowchart illustrating control processing in an application software in the second embodiment.

### DETAILED DESCRIPTION OF THE PREFERRED EMBODIMENT

### First Embodiment

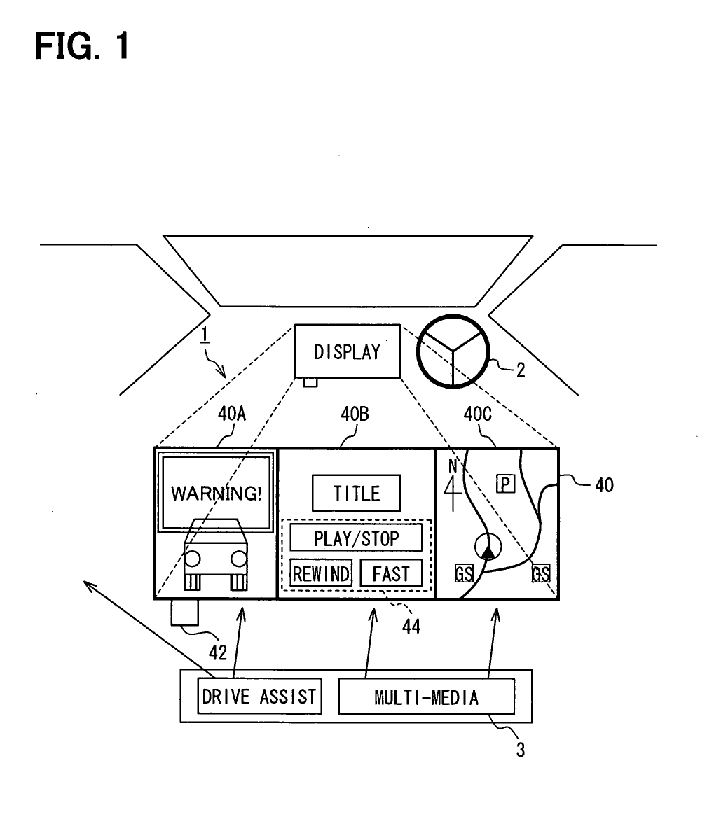

Referring first to FIG. 1, a car navigation device 1 is mounted next to a steering wheel 2 in a vehicle compartment. The car navigation device 1 has a microcomputer 3, a display 40, a speaker 42 and switches 44. The display 40 includes a monitor section 40A, an audio section 40B and a navigation section 40C.

The car navigation device 1 displays peripheral camera images that are not shown and provides drive assist information such as warning obstacles obtained by a front monitoring radar that is not shown, which contribute to the safety driving of a driver in addition to providing a navigation function such as a route guide and multi-media function such as audio/TV based on the display function of the display 40 and the voice output/sound output of the speaker 42.

Hereinafter, the functions which are not directly related to the safety while the vehicle is traveling despite the quality of service is deteriorated or lost, such as navigation function and audio function, are generally referred to as multi-media function, and the functions for improving the safety while a driver is driving, such as monitoring the peripheries (surrounding conditions) of the vehicle and detecting obstacles ahead, are referred to as drive assist function.

Route guide processing for guiding a route, multi-media control processing for realizing the multi-media function and drive assist processing for realizing the drive assist function are executed in on a single hardware in the microcomputer 3 of the car navigation device 1 to realize various functions.

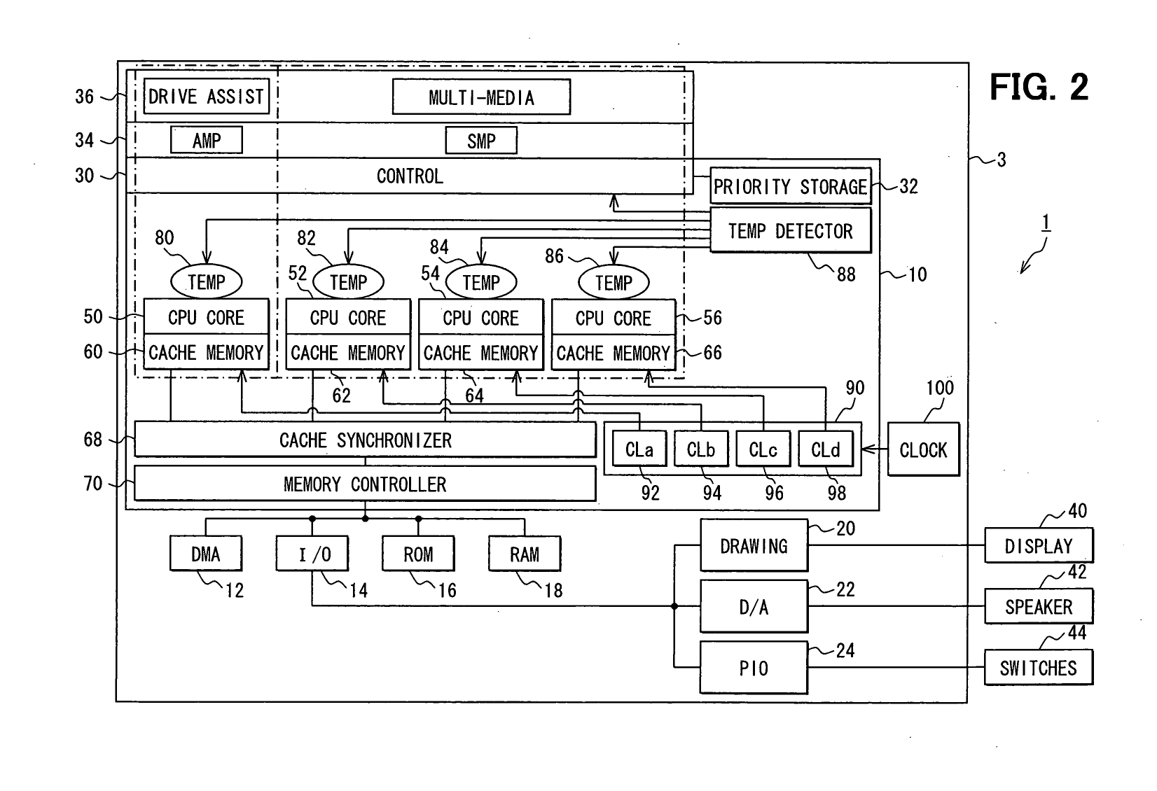

A system construction of the car navigation device 1 will be described next based on FIG. 2 which is a block diagram schematically illustrating the system construction of the car navigation device 1.

As shown in FIG. 2, the car navigation device 1 includes the microcomputer 3, the display 40, the speaker 42 and switches 44.

The microcomputer 3 includes, a multi-core CPU 10, a DMA 12, an I/O 14, a ROM 16, a RAM 18, a drawing LSI 20, a D/A converter 22, a PIO 24 and a reference clock generator 100.

The microcomputer 3 incorporates an operating system (OS) 34 for operating the microcomputer 3 and an application software 36.

The multi-core CPU 10 is a CPU for a mobile body (vehicle) constructed by a plurality of CPU cores 50, 52, 54, 56, which are assigned to execute different processing. For instance, the CPU cores 50, 52, 54, 56 execute drive assist processing, route guide processing, multi-media control processing, and the like, respectively.

The display 40 is for displaying the results of the route guide processing, multi-media control processing or safety drive assist processing executed by the microcomputer 3, and a liquid crystal display or a CRT is used. The speaker 42 is for informing the driver of the results of the route guide processing, multi-media control processing or safety drive assist processing executed by the microcomputer 3 by voice. The switches 44 are for making various inputs to the microcomputer 3 by the driver and are, concretely, touch sensors arranged on the screen of the display 40.

The multi-core CPU 10 includes first to fourth CPU cores 50, 52, 54, 56, first to fourth temperature sensors 80, 82, 84, 86, a processing priority storage unit 32, a CPU clock-forming unit 90, a control unit 30, first to fourth cache memories 60, 62, 64, 66, a cache synchronizer unit 68, a memory controller 70, and a temperature detector unit 88.

The multi-core CPU 10 is a CPU constructed by a plurality of CPU cores to which respective processing are assigned to be executed. This embodiment illustrates the case of a multi-core CPU constructed by the first CPU core 50, second CPU core 52, third CPU core 54 and fourth CPU core 56.

The first to fourth cache memories 60, 62, 64, 66, the first to fourth temperature sensors 80, 82, 84, 86, and clock registers (CL: CLa to CLd) 92, 94, 96 and 98 will be similarly described.

The first to fourth CPU cores 50 to 56 exhibit the same functions as the CPU having a single CPU core like operation, comparison and branching. The first to fourth CPU cores 50 to 56 all have the same internal structure. The respective CPU cores have independent cache memories 60, 62, 64 and 66 for suppressing a drop of performance due to memory access.

They further have a cache synchronizer portion 68 for bringing the contents of the first to fourth cache memories 60 to 66 into agreement. A memory controller 70 is connected to the cache synchronizer unit 68. The first to fourth CPU cores 50 to 56 are accessible to such chips as DMA 12, I/O 14, ROM 16 and RAM 18 through them.

The first to fourth temperature sensors 80, 82, 84 and 86 are for detecting the occurrence of an abnormal condition that drops the processing capability of the multi-core CPU 10, and are arranged close to the first to fourth CPU cores 50 to 56 to detect the temperatures of the first to fourth CPU cores 50 to 56, respectively.

The temperatures of the first to fourth CPU cores 50 to 56 detected by the first to fourth temperature sensors 80 to 86 are converted into digital values through the temperature detector unit 88, and are input to the control unit 30. The control unit 30 is so constructed as to grasp the temperatures of the first to fourth CPU cores 50 to 56.

The processing priority storage unit 32 stores the processing priorities assigned to the first to fourth CPU cores 50 to 56, and has a memory of a small capacity. The processing priority storage unit 32 further stores which one of the first to fourth CPU cores 50 to 56 be assigned to AMP or SMP, or stores a CPU clock frequency control map. The details of the AMP, SMP and CPU clock frequency control maps will be described later.

The CPU clock-forming unit 90 is for adjusting the processing capabilities of the first to fourth CPU cores 50 to 56. The CPU clock-forming unit 90 receives reference clocks from the reference clock generator 100. The CPU clock-forming unit 90 forms CPU operation clocks by multiplying the frequency of the input reference clocks by several times, and supplies them to the first to fourth CPU cores 50 to 56. Each CPU core executes the processing based on the clocks.

The CPU clock-forming unit 90 has clock-setting registers (CL: CLa to CLd) 92, 94, 96, 98 capable of specifying, in a software manner, the CPU operation clocks of a frequency of how many times as great as the frequency of the reference clocks can be formed at the time of forming the CPU operation clocks from the reference clocks.

Depending upon the values set to the CL 92 to 98, the CPU operation clock frequencies fed to the CPU cores 50 to 56 can be independently specified for each of the CPU cores. The CL 92 is linked or associated to the first CPU core 50, the CL 94 is linked to the second CPU core 52, and so on.

For example, the CL 92 is capable of specifying the CPU operation clock frequency fed to the first CPU core 50. If “1” is set to the CL 92 when the reference clock frequency is 100 MHz, then the CPU operation clock of a frequency of 100 MHz which is equal to the reference clock frequency can be fed to the first CPU core 50.

If “5” is set to the CL 92, then, the CPU operation clock of 500 MHz which is five times as great as the reference clock frequency (100 MHz) can be fed to the first CPU core 50. If “5” is set to the CL 92 and “4” is set to the CL 94, then the CPU operation clock of 500 MHz is fed to the first CPU core 50 and the CPU operation clock of 400 MHz is fed to the second CPU core 52. Thus, CPU operation clocks of different frequencies can be fed to the first to fourth CPU cores 50 to 56 based on the reference clock frequency.

Next, described below is processing executed by the control unit 30.

The software executed in each of the first to fourth CPU cores 50 to 56 includes supervisory processing in the least significant layer. The supervisory processing detects the temperatures of the first to fourth CPU cores 50 to 56 through temperature sensors, etc., determines the CPU operation clock frequencies for the first to fourth CPU cores depending upon the detected temperatures, and lowers the CPU operation clock frequencies so that the temperature of the CPU as a whole will not become too high to thereby execute the control processing.

The state of the CPU operation clock frequencies set by the supervisory processing can be referred to from another software (OS).

An OS layer is present over the supervisory processing executed by the control unit 30. Mounting technology of OS in the multi-core CPU can be represented by the following three examples.

(1) AMP (asymmetric multiprocessing): A particular software (task) is statically assigned to a particular single CPU core and is executed. Since the particular software (task) runs on the single CPU core, the real time performance and reliability can be guaranteed.
(2) SMP (symmetric multiprocessing): A software (task) is dynamically assigned to a plurality of CPU cores and is executed. The software (task) executed in parallel on the plurality of CPU cores features high performance making it, however, difficult to guarantee the real time performance and reliability. In the SMP, the coherency of caches adjacent the CPU cores must be maintained among the plurality of CPU cores. In this case, the symmetric multiprocessing is so mounted as to maintain coherency in the cache synchronizer unit 68 in the multi-cure CPU.

### (3) BMP (bound multiprocessing): A hybrid construction of AMP and SMP, in which the CPU cores are partly assigned to the AMP and other CPU cores are assigned to the SMP.

The car navigation device 1 of the BMP is usually considered advantageous in that the drive assist function which requires reliability can be mounted as the AMP and the multi-media function which requires high performance can be mounted as the SMP.

The first embodiment will be described below assuming that the BMP is used as the OS 34.

The first CPU core 50 is assigned to the AMP, and the second CPU core 52, third CPU core 54 and fourth CPU core 56 are assigned to the SMP; i.e., the drive assist software is executed on the AMP and the multi-media software is executed on the SMP.

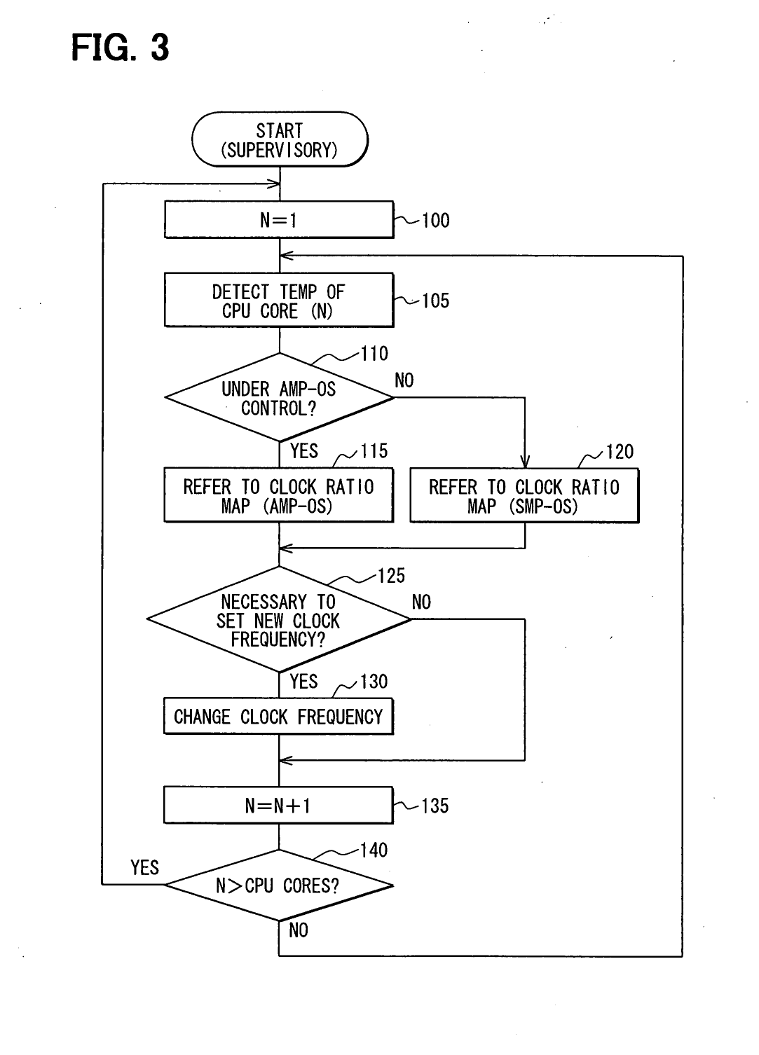

The supervisory processing is shown in FIG. 3. This supervisory processing may be regularly started from a basic timer of AMP or SMP, or the basic timer may be set to each of the CPU cores and may be regularly executed with the regular interruption.

In the CPU capable of specifying a privileged mode as a right for executing the supervisory processing, it is desired that the supervisory processing only is mounted so as to be executed with the privileged mode, so that software other than the supervisory processing will not undesirably vary the registers (CLa to CLd) 92 to 98 for setting the CPU core operation clock frequencies by bug.

The supervisory processing reads in advance from the processing priority storage unit 32 which one of the CPU cores 50 to 56 is assigned to the AMP or the SMP, and stores it as internal data.

After the start of the supervisory processing, a variable N is first set to 1 at step 100.

At next step 105, the temperature of the first CPU core 50 is input from the first temperature sensor 80 attached to the first CPU core 50.

Next, at step 110, it is checked if the first CPU core 50 is under the control of AMP-OS. If the first CPU core 50 is under the control of AMP-OS (110: Yes), the routine proceeds to step 115 to be under the control of AMP-OS. In other word, if it is under the control of SMP-OS (110: No), the routine proceeds to step 120.

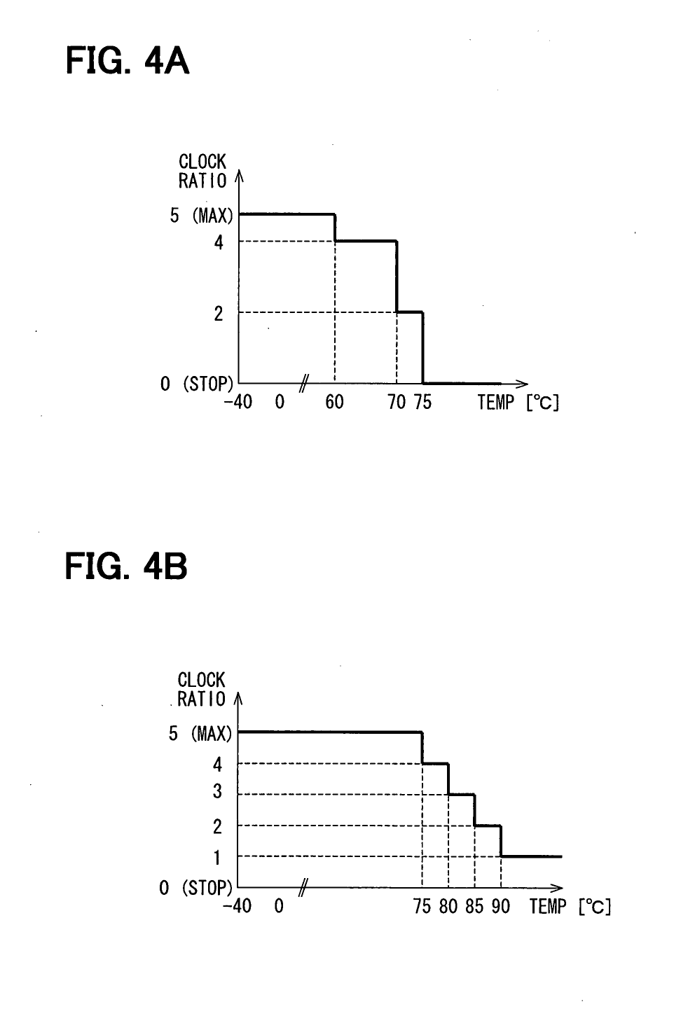

At step 115, reference is made to an AMP side CPU clock frequency control map stored in the processing priority storage unit 32 as shown in FIG. 4A to set the CPU operation clock frequency of the first CPU core 50. The CPU clock frequency control map determines the CPU clock multiplying factor (clock frequency ratio) that are to be set for the temperatures of the first to fourth CPU cores 50 to 56. This map defines that the frequency is lowered as the temperature rises, and the frequency is reduced to zero at 75° C. to stop processing operation because of lower priority processing.

At step 120, reference is made to an SMP side CPU clock frequency control map stored in the processing priority storage unit 32 as shown in FIG. 4B to set the CPU operation clock frequency of the first CPU core 50. This map also defines that the frequency is lowered later than the case in FIG. 4A as the temperature rises, and the frequency is not reduced to zero but maintained even over 90° C. to maintain processing operation because of highest priority processing.

At next step 125, it is checked if a clock multiplying factor must be set for the first CPU core 50. Specifically, it is checked if the present CPU operation clock frequency is the same as the CPU operation clock frequency that is to be set in correspondence to the detected temperature. If they are different and it is necessary to set a new frequency (125: Yes), the routine proceeds to step 130. If they are not different, the routine proceeds to step 135.

At step 130, a clock multiplying factor referred to from the above clock frequency control map is set to the first CL 92 that determines the CPU operation clock frequency to be fed to the first CPU core 50 to thereby change the clock frequency to be fed.

At next step 135, a value of the variable N is increased by 1 and at next step 140, it is checked if the variable N is in excess of the number (four in this embodiment) of the CPU cores. If the variable N is in excess of 4 (140: Yes), the routine proceeds to step 100 where the supervisory processing is repeated from the first CPU core 50 again.

If the variable N is not in excess of 4 (140: No), the routine proceeds to step 105 where the processing is executed for the second CPU core 52 to execute steps 105 to 140. By repeating the above steps, the CPU operation clock frequencies are set to all of the first to fourth CPU cores 50 to 56.

The processing to set the CPU operation clock frequencies to the CPU cores is executed when the supervisory processing is executed. Here, it is presumed that the reference clock frequency to the multi-core CPU is 100 MHz, and the temperatures of the first to fourth CPU cores 50 to 56 are all the same.

When the CPU core temperature is not higher than 60° C., the first to fourth CPU cores 50 to 56 all operate at a CPU clock multiplying factor 5 (i.e., at a CPU operation clock frequency of 500 MHz) as shown in FIGS. 4A and 4B.

Here, it is also assumed that abnormal condition has occurred in a cooling fan for the CPU, and the rotational speed of the fan has decreased. If it becomes difficult to maintain a heat radiating amount as designed due to a drop in the rotational speed of the fan, the temperatures of the first to fourth CPU cores 50 to 56 rise gradually.

At a moment when the CPU core temperature has reached 60° C. as shown in FIG. 4A, the CPU clock multiplying factors of the second to fourth CPU cores 52 to 56 executing the SMP side become 4, and the CPU operation clock frequency decreases from 500 MHz down to 400 MHz.

Therefore, due to a drop in the processing performance of the second to fourth CPU cores 52 to 56, the multi-media software executed on the SMP side may become no longer capable of maintaining predetermined functions. However, the drive assist software on the AMP side continues to operate as before in the state of operation at 500 MHz.

In case the heat radiating amount keeps balance with the heat generation amount of the multi-core CPU 10 itself, the temperatures of the first to fourth CPU cores 50 to 56 are not elevated any more, and the operation continues in this state. However, if the heat heating amount is insufficient, the temperatures of the first to fourth CPU cores 50 to 56 may further elevate.

Next, as the CPU core temperature reaches 70° C., the CPU clock multiplying factors of the second and third CPU cores 52 to 54 executing on the SMP side become 2 as shown in FIG. 4A, and the CPU operation clock frequency further decreases from 400 MHz down to 200 MHz.

In this case, too, as shown in FIG. 4B, the CPU clock multiplying factor of the first CPU core 50 executing on the AMP side is 5. Therefore, the first CPU core 50 continues to operate as before maintaining the CPU operation clock frequency of 500 MHz.

If the temperature of the CPU core does not still stop rising and reaches 75° C., the CPU clock multiplying factor of the second to fourth CPU cores 52 to 54 on the SMP side is set to 0 as shown in FIG. 4A to completely halt the CPU operation clock. As shown in FIG. 4B, further, the CPU clock multiplying factor of the first CPU core 50 on the AMP side is set to 4 to decrease the CPU operation clock frequency from 500 MHz down to 400 MHz.

In case the CPU operation clock frequencies of the CPU cores have decreased due to a rise in the temperature of the multi-core CPU, it is desired to inform the driver of the occurrence of some trouble in the hardware and to so construct the system that the driver does not feel a drop in the function caused by the trouble, if it is possible.

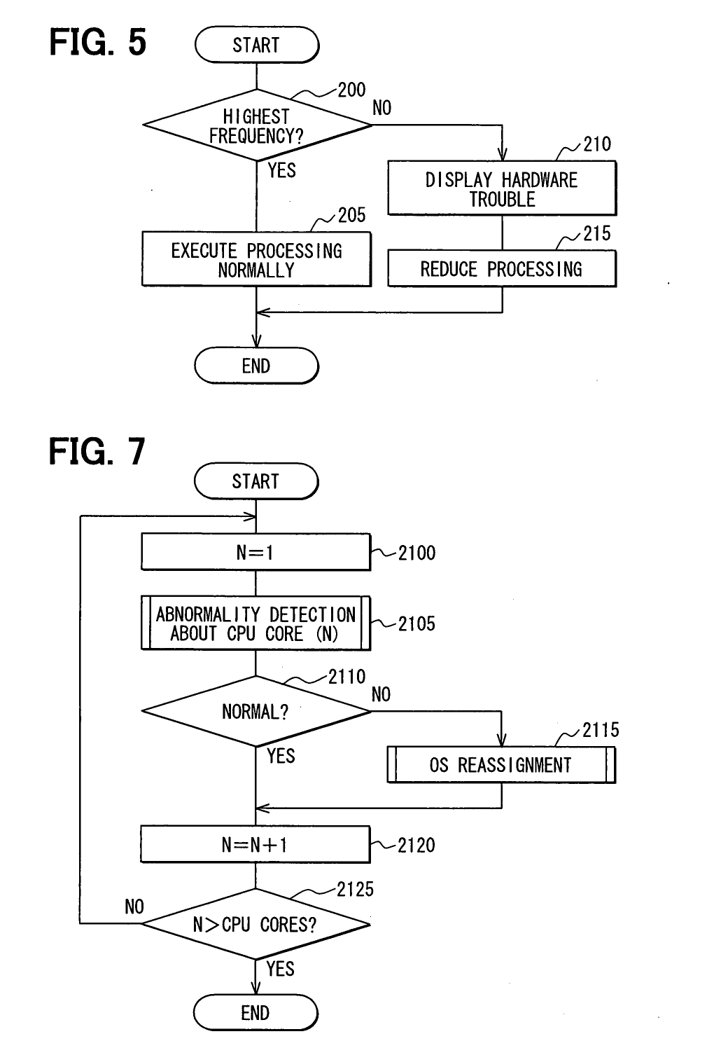

This control processing is executed in the application software for the above purpose as shown in FIG. 5.

First, at step 200, it is checked if the CPU clock multiplying factors that have been set to the first to fourth CPU cores 50 to 56 are the highest (maximum). This multiplying factor of the first to fourth CPU cores 50 to 56 may be retrieved from the control unit 10.

If the CPU clock multiplying factor is the highest multiplying factor (200: Yes), the routine proceeds to next step 205. If the CPU clock multiplying factor is not the highest multiplying factor (200; No), the routine proceeds to step 210.

At step 205, processing is executed like the one that is normally executed for the application software. At step 210, on the other hand, a trouble that has occurred in the hardware is displayed on the display 40. At next step 215, the first to fourth CPU cores 50 to 56 are processed to reduce the processing for the application software.

At the time of developing the application, for example, processing procedure is provided to reduce the processing load to execute the processing even when the CPU operation clock frequency has decreased in addition to when the first to fourth CPU cores 50 to 56 are executed with full power, and the processing load is switched over to the processing of a light load when the previous CPU operation clock frequency has decreased so will not to impair the holding of the system.

For instance, a DVD playback of a multi-media software may be controlled as follows. It is so designed that the playback is performed with a surround voice of 5.1 channel at a frame rate of 30 Hz, when executed in full power. When the CPU operation clock frequency of the first to fourth CPU cores 50 to 56 has decreased, this decrease is detected and the playback is switched over to the stereo voice of a frame rate of 15 Hz and 2 channel to provide a service without offensive feeling, without causing the frame of dynamic display to be reduced or without causing the voice to be interrupted even in case the capability of the CPU has dropped.

According to the above car navigation device 1, when it is detected by the first to fourth temperature sensors 80, 82, 84, 86 that the temperature of any one of the first to fourth CPU cores 50 to 56 has reached a predetermined temperature, the CPU operation clock frequencies of the second to fourth CPU cores 52, 54, 56 are lowered except that of the first CPU core 50 to which the processing of the highest priority is assigned among a plurality of processing assigned to the first to fourth CPU cores 50, 52, 54 and 56.

In case the abnormal condition is caused by a rise of ambient temperature of the multi-core CPU 10 or by an increase in the heat generation amount of the multi-core CPU 10 itself, the temperature of the multi-core CPU 10 decreases if the heat generation of the second to fourth CPU cores 52 to 56 is lowered. If the temperature is lowered, the processing capabilities of the second to fourth CPU cores 52, 54, 56 do not have to be lowered.

Further, the vehicle safety travel control processing, route guide processing and audio equipment control processing are assigned to the first to fourth CPU cores 50 to 56 in order of decreasing priorities.

If the temperatures of the first to fourth CPU cores 50 to 56 have reached a predetermined value, the CPU operation clock frequencies of the second to fourth CPU cores 52 to 56 are lowered except that of the first CPU core 50 to which is assigned the vehicle safety travel control processing having the highest degree of processing priority. Namely, performances of the route guide processing and audio equipment control processing are lowered, which are less critical to vehicle safety traveling.

Thus, the temperature of the multi-core CPU 10 can be lowered by lowering the CPU operation clock frequencies of the second to fourth CPU cores 52 to 56 to which are assigned processing of lower priorities. Since the temperature of the multi-core CPU 10 can be lowered, the CPU operation clock frequency of the first CPU core 50 can be maintained at the normal value. That is, the vehicle safety travel control can be executed maintaining ordinary performance.

Further, in case the temperature of any one of the first to fourth CPU cores 50 to 56 assumes an abnormal temperature as measured by the first to fourth temperature sensors 80 to 86, i.e., in case the temperature becomes higher than the predetermined value, the CPU operation clock frequencies of the second to fourth CPU cores 52 to 56 are lowered except that of the first CPU core 50 to which is assigned the processing having the highest degree of priority making it possible to decrease the heat generation amount of the second to fourth CPU cores 52 to 56 except that of the first CPU core 50 to which is assigned the processing of the highest degree of priority.

In the above embodiment, if it is difficult to install the first to fourth independent temperature sensors 80 to 86 for each of the first to fourth CPU cores 50 to 56, then only one temperature sensor may be installed which is capable of detecting the temperature of the multi-core CPU 10 as a whole to thereby detect the temperature of the single multi-core CPU 10.

In the above embodiment, only one CL may be provided to set the CPU operation clock frequency that is fed to all of the second to fourth CPU cores 52 to 56. This simplifies the construction of the CPU clock-forming unit 90 and is convenient.

### Second Embodiment

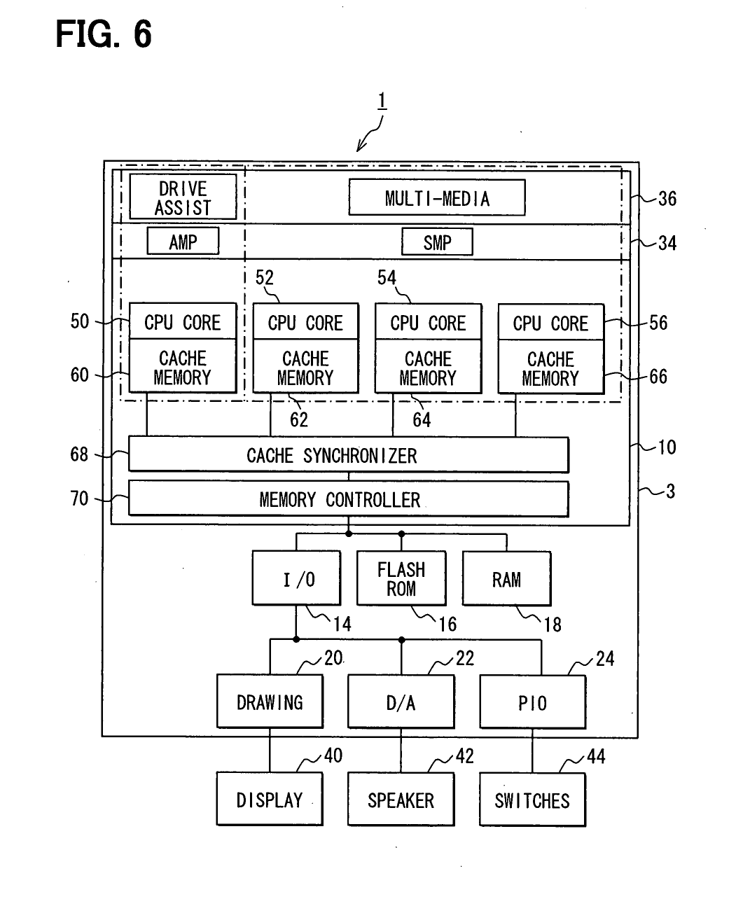

A car navigation system 1 includes, as shown in FIG. 6, a microcomputer 3, a display 40, a speaker 42 and switches 44.

The microcomputer 3 includes, a multi-core CPU 10, an I/O 14, a flash ROM 16, a RAM 18, a drawing LSI 20, a D/A converter 22 and a PIO 24.

The multi-core CPU 10 is a CPU for a mobile body constructed by a plurality of (four) CPU cores 50, 52, 54, 56, which are assigned to execute different processing. That is, drive assist processing, route guide processing, multi-media control processing and the like are assigned to the first to fourth CPU cores 50 to 56, respectively.

The microcomputer 3 of the car navigation device 1 incorporates an operating system (OS) 34 for operating the microcomputer 3 and an application software 36.

The OS 34 includes abnormal condition detection processing for detecting whether an abnormal condition which is not capable of normally executing the operation has occurred in any one of the plurality of CPU cores, and assigning processing which, when an abnormal condition which is not capable of normally executing the operation is detected in any one of the plurality of CPU cores 50 to 56 due to the abnormal condition detection processing, assigns the processing that has been assigned to the first CPU core 50 which is detected to be abnormal to a CPU core other than the CPU cores 52 to 56 from which the abnormal condition is detected, according to a predetermined order of processing priorities.

The CPU core number used for the assigning processing and the CPU condition data storing the normal/abnormal condition of the CPU core are stored in the flash ROM 16. Namely, even if the system power source is turned off, the data can be utilized at the start of the next time, and a defective CPU core can be cut off from the system without confirming abnormal CPU cores 50 to 56 again.

Mounting technology of OS 34 which is executed by assigning the processing to the plurality of CPU cores 50 to 56 can be represented by the following three examples.

(1) AMP (asymmetric multiprocessing): Executed by statically assigning a particular software (task) to a particular single CPU core. Since the particular software (task) runs on the single CPU core, the real time performance and reliability can be guaranteed.
(2) SMP (symmetric multiprocessing: object type multi-processing): Executed by dynamically assigning a software (task) to a plurality of CPU cores. The software (task) is executed in parallel on the plurality of CPU cores featuring high performance making it, however, difficult to guarantee the real time performance and reliability. In the SMP, the coherency of caches linked to or associated with the CPU cores must be maintained among the plurality of CPU cores. In this case, the symmetric multiprocessing is so mounted as to maintain coherency in the cache synchronizer means in the multi-cure CPU.

### (3) BMP (bound multiprocessing): A hybrid construction of AMP and SMP, in which the CPU cores are partly assigned to the AMP and other CPU cores are assigned to the SMP.

In the car navigation device 1, the BMP is usually considered to be advantageous in that the drive assist function which requires reliability can be mounted as the AMP and the multi-media function which requires high performance can be mounted as the SMP. The second embodiment will be described hereinafter presuming that the BMP is used as the OS.

The first CPU core 50 is assigned to the AMP, and the second CPU core 52 to fourth CPU core 56 are assigned to the SMP; i.e., the drive assist software is executed on the AMP and the multi-media software is executed on the SMP. In case the first CPU core 50 to the fourth CPU core 56 become abnormal, however, the assignment varies dynamically.

The processing of the OS 34 that is executed when abnormal condition has occurred in the first to fourth CPU cores 50 to 56 are shown in FIGS. 7 to 11.

The OS 34 may be regularly started from a basic timer of AMP or SMP, or a basic timer may be set to the first to fourth CPU cores 50 to 56 so as to be regularly executed with a regular interruption. In the CPU capable of specifying a privileged mode as a right for executing the OS 34, it is desired that the OS 34 only is mounted so as to be executed with the privileged mode, so that software other than the OS 34 will not cause the system to lose stability by bug.

The OS 34 holds in advance which one of the first to fourth CPU cores 50 to 56 is assigned to the AMP or the SMP as internal information.

In the main processing of the OS 34, shown in FIG. 7, variables N representing the specified one of the first CPU core 50 to the fourth CPU core 56 are set to 1 (indicating the first CPU core) at step 2100. At next step 2105, abnormality detection processing is executed with respect to the first CPU core 50.

At next step 2110, it is checked if the first CPU core 50 is normal. If the first CPU core 50 is determined to be normal (2110: Yes), the routine proceeds to step 2120. If the first CPU core 50 is determined to be not normal (i.e., the first CPU core 50 is abnormal) (2110: No), the routine proceeds to step 2115.

At step 2115, the reassigning processing (content of processing will be described later) is executed and at step 2120, the variable N is increased by 1. At next step 2125, it is checked if the variable N has exceeded the number of all the CPU cores (four).

If it is determined at step 2125 that the variable N is not exceeding the number of the first CPU core 50 to the fourth CPU core 56 (2125: No), the routine proceeds to S2100, and the processing is executed for the second CPU core 52. If it is determined that the variable N is exceeding the number of the first CPU core 50 to the fourth CPU core 56, the processing ends.

As described above, the processing is executed for all of the first CPU core 50 to the fourth CPU core 56.

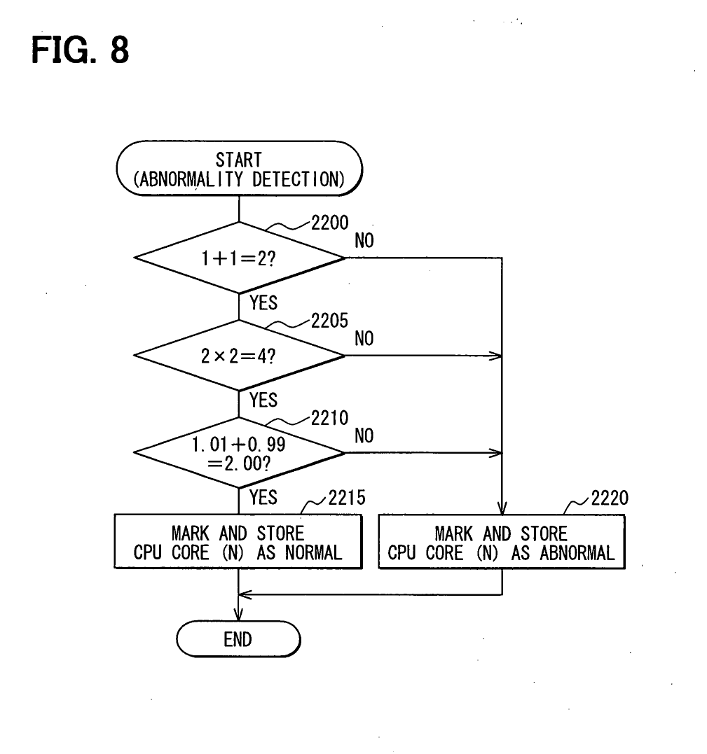

In the processing for detecting abnormal condition, shown in FIG. 8, addition “1+1” is effected at step 2200, and it is checked if the added result is “2”. If the added result is not “2” (2200: No), the fact that the CPU core (N) is abnormal is marked and stored in the flash ROM 16 at step 2220.

If the added result is “2” (2200: Yes), on the other hand, the multiplication “2×2” is effected at step 2205 and it is checked if the multiplied result is “4”. If the multiplied result is not “4” (2205: No), the fact that the CPU core (N) is abnormal is marked and stored in the flash ROM 16 at step 2220.

If the added result is “4” (2205: Yes), on the other hand, the addition inclusive of a total number of “1.01+0.99” is effected at step 2210, and it is checked if the added result is “2.00”. If the added result is not “2.00” (2210: No), the fact that the CPU core (N) is abnormal is marked and stored in the flash ROM at step 2220.

On the other hand, if the added result is “2.00” (2210: Yes), the fact that the CPU core (N) is normal is marked and stored in the flash ROM 16 at next step 2215.

In the processing for detecting abnormal condition as described above, the processing of which the result has been known is effected for each of the first to fourth CPU cores 50 to 56. If there is even one CPU core which is not normal, then the CPU core is regarded to be abnormal.

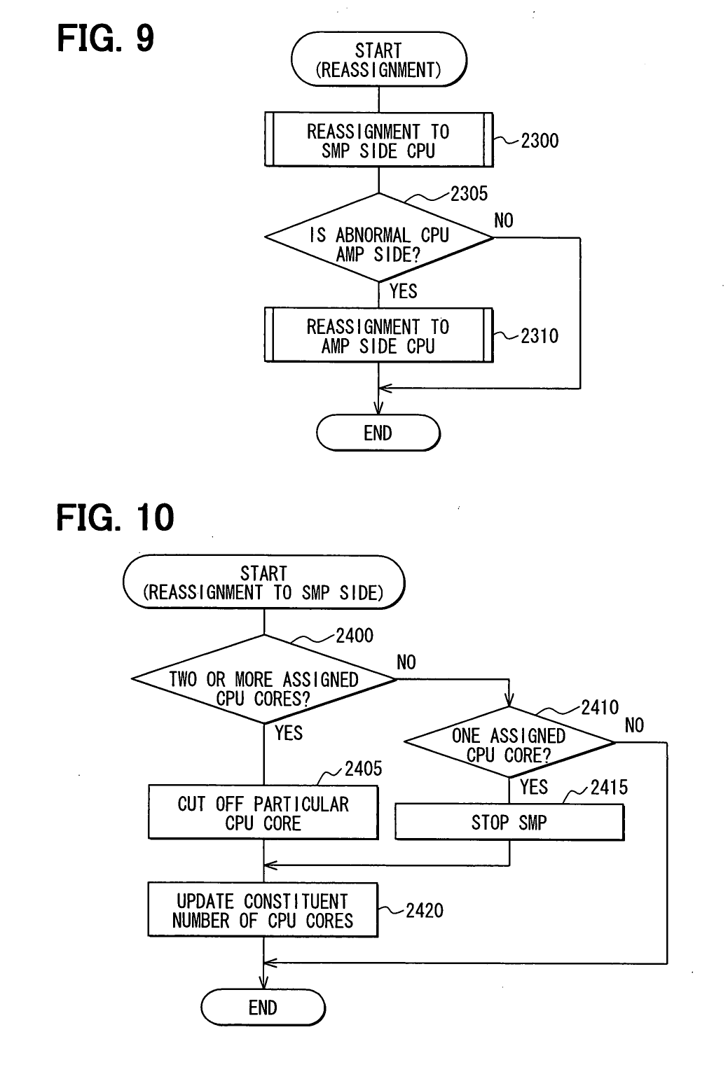

Next, reassigning processing will be described with reference to FIG. 9.

In the reassigning processing of FIG. 9, the processing is reassigned to the SMP side CPU at step 2300. At next step 2305, it is checked if the abnormal CPU core (N) is assigned to the AMP side.

If the abnormal CPU core (N) is assigned to the AMP side at step 2305 (2305: Yes), the reassigning processing is executed at next step 2310 for the CPU core (N) that has been assigned to the AMP side. On the other hand, if the abnormal CPU core (N) has not been assigned to the AMP side at step 2305 (2305: No), the processing ends.

In the reassigning processing as described above, neither the AMP nor the SMP is assigned to the CPU core (N) in which the abnormal condition has occurred, and the AMP and SMP are assigned to the normal CPU cores (except N) to execute the drive assist software having the highest degree of priority.

In processing for reassigning to the SMP side CPU cores, as shown in FIG. 10, it is first determined at step 2400 if the number of the CPU cores assigned to the SMP side is not less than 2. If the number of the CPU cores that are assigned is not less than 2 (2400: Yes), a particular CPU core is cut off from the SMP side at step 2405. That is, the particular CPU core is prevented from being assigned to the SMP. Thereafter, the routine proceeds to step 2420.

If the number of the CPU cores that are assigned are less than 2 (2400: No), on the other hand, it is determined at step 2410 if the number of the CPU cores assigned to the SMP side is 1.

If the number of the CPU core that is assigned is 1 (2410: Yes), the processing of SMP is stopped at next step 2415, and the routine proceeds to step 2420. If the number of the CPU cores that are assigned is not 1 (2410: No), the processing ends.

At step 2420, the constituent numbers of the CPU cores assigned to the SMP side are updated except those of the CPU cores that are cut off or for which no processing is executed, since the CPU core has been cut off at step 2405 or the SMP processing has been discontinued at step 2415.

For example, when the second CPU core 52 to the fourth CPU core 56 are assigned to the SMP side but the second CPU core 52 is cut off at step 2405, the third CPU core 54 becomes the second CPU core 52, and the fourth CPU core 56 becomes the third CPU core 54.

The processing ends after the constituent numbers of the CPU cores are updated.

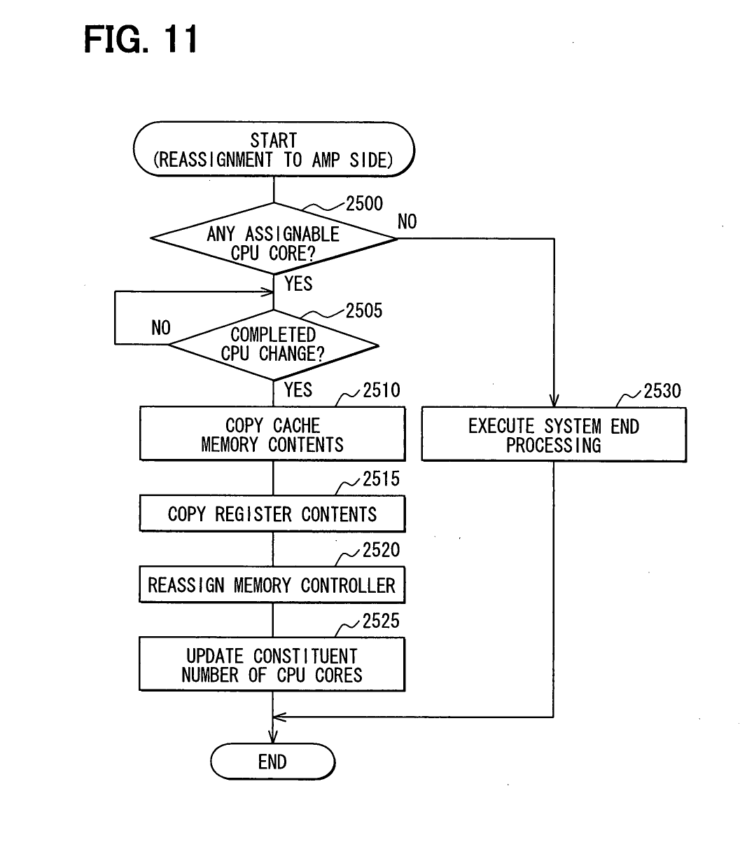

In processing for reassigning to the AMP side CPU cores, as shown in FIG. 11, it is first determined at step 2500 if there is a CPU core that can be assigned. This is determined depending upon if there are, on the SMP side, the CPU cores of a number that can be cut off from the SMP.

If there is no CPU that can be assigned (2500: No), the routine proceeds to step 2530. If there is a CPU core that can be assigned (2500: Yes), change of the CPU core over to the CPU core that can be assigned is waited for at step 2505. After the CPU change is over or completed, the routine proceeds to step 2510.

If there are a plurality of CPU cores that can be changed over, the CPU core is changed over to the one having a small constituent number of the CPU core. For example, if the CPU core can be changed over to the second CPU core 52 or to the third CPU core 54, then the CPU core is changed over to the second CPU core 52.

At step 2510, the contents of the cache memories 60 to 66 of the CPU core from which to change are copied into the cache memories 60 to 66 of the CPU core over which to change, so that the operation data of the CPU core from which to change become the same as the operation data of the CPU core over which to change.

At next step 2515, the content of the register which is not shown in the CPU core from which to change is copied to the register which is not shown in the CPU core over which to change, so that the operation data in the CPU core from which to change become the same as the operation data in the CPU core over which to change.

At next step 2520, the memory controller 70 is operated, so that the memory space becomes the same as the execution environment in the CPU core from which to change. Thereafter, at step 2525, the constituent numbers of the CPU cores are updated to end the processing.

At step 2530, a system end processing is executed. This processing informs the application software (drive assist software and multi-media software) of the occurrence of abnormal condition in all of the first to fourth CPU cores 50 to 56.

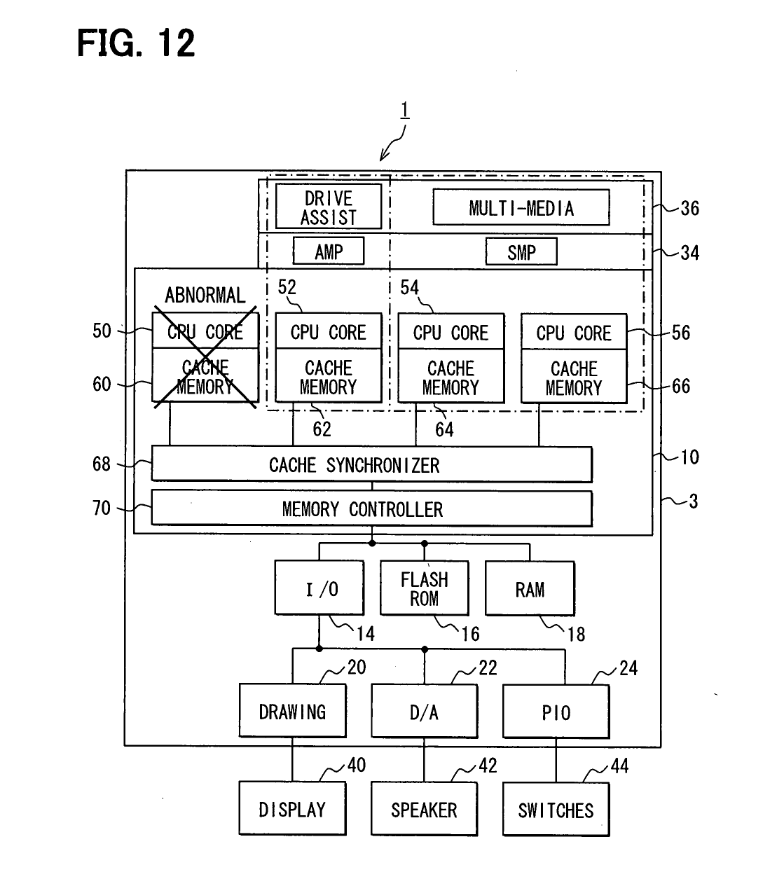

Described below with reference to FIG. 12 is how the software construction will be in the microcomputer 3 in case an abnormal condition has occurred in the first CPU core 50 in the state of FIG. 6 as a result of the above processing.

If an abnormal condition occurs in the first CPU core 50, the AMP and the AMP side application software (drive assist software) that had been executed by the first CPU core 50, are now executed by the second CPU core 52. The SMP/SMP side application software (multi-media software) that had been executed by the second CPU core 52 to the fourth CPU core 56 are now executed by the third CPU core 54 and the fourth CPU core 56.

As described earlier, the drive assist software is directly related to the safety of the driver and must be reliably executed. According to the OS 34 of this embodiment, even if the first CPU core 50 becomes defective or abnormal, the drive assist software that had been executed by the first CPU core 50 is simply changed over to the second CPU core 52 which has the same processing capability as that of the first CPU core 50. Therefore, the same service is provided to the driver.

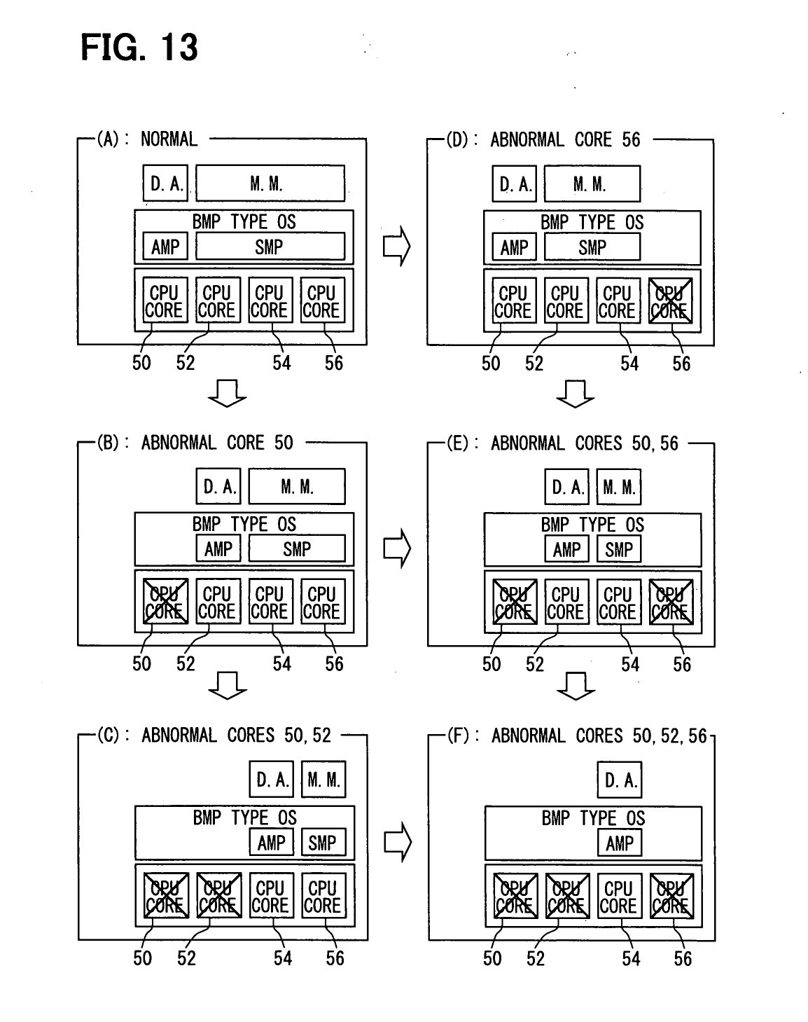

Next, described with reference to FIG. 13 is a relationship of transition in a state where the operating system and the application software are assigned in case abnormal conditions have occurred in the CPU cores in a state where the multi-core CPU 10 is normally operating.

When normally operating as shown in (A) of FIG. 13, the drive assist software (D.A.) is executed by the first CPU core 50 under the control of AMP, and the multi-media software (M.M.) is executed by the second CPU core 52 to the fourth CPU core 56 under the control of SMP.

Next, as shown in (B) of FIG. 13, in case an abnormal condition has occurred in the first CPU core 50 as indicated by a crossing X, the drive assist software and the AMP are assigned to the second CPU core 52, and the multi-media software and the SMP are assigned to the third CPU core 54 and to the fourth CPU core 56 so as to be executed.

Further, as shown in (C) of FIG. 13, in case another abnormal condition has occurred in the second CPU core 52, the drive assist software and the AMP are assigned to the third CPU core 54, and the SMP and the multi-media software are assigned to the fourth CPU core 56 so as to be executed.

As shown in (D) to (F) of FIG. 13, further, depending upon the abnormal condition that has occurred in the first CPU core 50 to the fourth CPU core 56, the drive assist software, AMP, multi-media software and SMP are assigned to the CPU cores that are not developing abnormal condition.

Thus, as the drive assist software and the multi-media software assigned to the CPU cores are dynamically shifted due to the OS 34, the drive assist software is handled with the utmost priority over various abnormal conditions, and the system as a whole works to maintain safety.

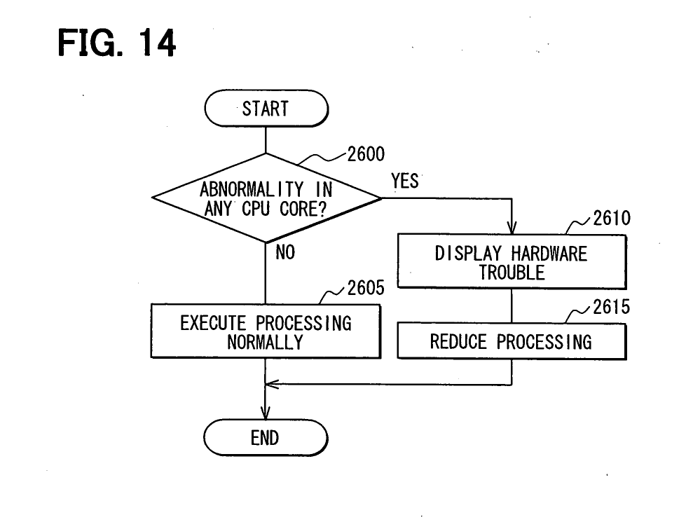

In case an abnormal condition has occurred in any one of the first to fourth CPU cores 50 to 56, it is desired to inform the driver of the occurrence of some trouble in the hardware and to so fabricate the system that the driver does not feel a drop in the function caused by the trouble, if it is possible. FIG. 14 shows a flowchart of a control processing in the application software 36 for the above purpose.

The control processing is regularly executed in the application software 36. First, at step 2600, the states of the first to fourth CPU cores 50 to 56 are obtained from the OS 34, and it is determined if any one of the first to fourth CPU cores 50 to 56 is under abnormal condition.

If abnormal condition is occurring in none of the first to fourth CPU cores 50 to 56 (2600: No), the routine proceeds to step 2605. If abnormal condition is occurring in any one of the first to fourth CPU cores 50 to 56 (2600: Yes), the routine proceeds to step 2610.

At step 2605, the application software 36 executes processing normally. At step 2610, on the other hand, a trouble that has occurred in the hardware is displayed on the display 40 and at next step 2615, the first to fourth CPU cores 50 to 56 are processed to reduce the processing for the application software 36.

At the time of developing the application software 36, for example, a processing procedure is provided to reduce the processing load to execute the processing even when an abnormal condition has occurred in any one of the first to fourth CPU cores 50 to 56 in addition to when the first to fourth CPU cores 50 to 56 are normal, and the processing load is switched over to the processing of a light load in case an abnormal condition has occurred in any one of the first to fourth CPU cores 50 to 56 so will not to impair the holding of the system.

Specifically, referring to an example of DVD playback of multi-media software, when the first to fourth CPU cores 50 to 56 are normal, it is played back with the surround voice of a frame rate of 30 Hz and 5.1 channels. If an abnormal condition has occurred in any one of the first to fourth CPU cores 50 to 56, the playback is switched over to the stereo voice of a frame rate of 15 Hz and 2 channels. Thus, even in case an abnormal condition has occurred in any one of the first to fourth CPU cores 50 to 56, a service is provided without offensive feeling, without causing the frame of dynamic display to be lacked or without causing the voice to be interrupted.

According to the above car navigation device 1, if an abnormal condition which makes it difficult to normally execute the operation is detected in any one of the first to fourth CPU cores 50 to 56, the processing executed by the first CPU core 50 is assigned to the other CPU cores 52 to 56 depending upon the degree of priority.

Therefore, even if the abnormal condition occurs in the CPU core 50 to which is assigned processing (drive assist software) having the highest degree of priority, the processing that is executed is assigned to the other second to fourth CPU cores 52 to 56. Therefore, if there is even only one CPU core that is normally operating, the drive assist software having the highest degree of priority is executed without being interrupted.

Thus, in case the abnormal condition has occurred in the first CPU core 50 to which is assigned the drive assist software having the highest degree of priority, the processing can be executed by other second to fourth CPU cores 52 to 56. Therefore, the drive assist software having the highest degree of priority can be executed at all times. That is, the vehicle safety travel control can be executed maintaining the same normal performance.

In case abnormal conditions have occurred in all of the first to fourth CPU cores 50 to 56, the system end processing (2530) informs the application software 36 of the fact that the system is not normally operating (2530 in FIG. 11).

Upon receipt of this notice, therefore, the application software 36 inhibits the operation of the drive assist software and displays on the display 40 not to execute the drive assist. Then, the drive assist processing does not produce error, and safety of the vehicle can be maintained.

In the second embodiment, a simple addition or a multiplication of which the result has been known is executed to determine that the result is correct, and abnormal condition is detected being limited to the first to fourth CPU cores 50 to 56. Not being limited to the first to fourth CPU cores 50 to 56, however, provision may be made of a plurality of equivalent circuits such as cache memories, and the object of detection may be expanded to the elements that can be switched over to other circuits in case of a trouble.

In this case, however, the first to fourth CPU cores 50 to 56 being detected is not allowed to execute the software processing for realizing the function of the car navigation device 1 during the period of detecting the abnormal condition. Namely, the precision of detection and the system performance is in a trade-off relationship, and to which degree the detection can be made must be determined at the time of designing the system relying upon a level of reliability required for the car navigation device 1 itself.

Further, if the system performance permits, the constituent elements forming the CPU cores, such as fetch circuit, decoding circuit, operation circuit, external access circuit, register, etc. may be so constructed as can be all detected.

In the above first and second embodiments, the 3D map display that exerts a high processing load on the navigation software may be limited while the clock frequency is being lowered and, instead, the two-dimensional map may be mainly displayed.

What is claimed is:

1. A device for a mobile body comprising:
a multi-core CPU including a plurality of CPU cores to which different processing are assigned, respectively;
abnormal condition detection means for detecting an abnormal condition that lowers processing capability of the multi-core CPU;
priority storage means for storing priority degrees of the respective processing assigned to the plurality of CPU cores;
capability adjusting means for adjusting processing capabilities of the plurality of CPU cores; and
control means which, when the abnormal condition is detected, controls the capability adjusting means to lower the processing capabilities of the CPU cores depending upon the priority degrees except that of a specified CPU core among the plurality of CPU cores, the specified CPU core being assigned a highest degree of priority in the priority storage means.

2. The device according to claim 1, wherein the capability adjusting means adjusts all of the processing capabilities of the CPU cores except the specified CPU core.

3. The device according to claim 1, wherein:
the abnormal condition detection means detects at least any one of the temperatures of the plurality of CPU cores that has exceeded a predetermined value as abnormal condition that lowers the processing capability of the multi-core CPU for the mobile body; and
the capability adjusting means lowers operation clock frequencies of the CPU cores except that of the specified CPU core.

4. The device according to claim 3, wherein:
the control means controls the capability adjusting means to lower both operation clock frequencies of the specified CPU core and other CPU cores as the temperature of the plurality of CPU cores rises; and
a temperature for lowering the operation clock frequency of the specified CPU core from a highest frequency is higher than a temperature for lowering the operation clock frequency of the other CPU cores from the highest frequency.

5. The device according to claim 3, wherein:
the control means controls the capability adjusting means to stop operations of the other CPU cores and maintain an operation of the specified CPU core at a predetermined highest temperature.

6. The device according to claim 1, wherein:
the specified CPU core executes processing of assisting a vehicle drive; and
the CPU cores other than the specified CPU core execute other processing which are not related to the assisting of a vehicle drive.

7. An operating system for a multi-core CPU for a mobile body including a plurality of CPU cores to which different processing are assigned, respectively, the operating system comprising:
abnormal condition detection processing for detecting an abnormal condition that indicates incapability of assigned processing in any one of the plurality of CPU cores; and
reassigning processing which, when the abnormal condition is detected, reassigns the processing that has been assigned to an abnormal one of the plurality of CPU cores to a normal one of the plurality of CPU cores other than the abnormal one depending upon a predetermined order of priorities.

8. The operating system according to claim 6, wherein, when the abnormal condition detection processing detects that all of the plurality of CPU cores are abnormal, the reassigning processing executes processing necessary for ending all of the processing assigned to the plurality of the CPU cores and thereafter stops all of the processing of the plurality of the CPU cores.

9. A program medium for having a computer for a mobile body equipped with a multi-core CPU execute a function of the operating system of claim 6.

10. A device for assisting an operation of a mobile body equipped with the operating system for a multi-core CPU for a mobile body of claim 6.
